(19) United States
(12) Patent Application Publication
(10) Pub. No.: US 2008/0012917 A1
(43) Pub. Date: Jan. 17, 2008

(54) Method of printing an image on the side of publication

(76) Inventor: James John Benard, New York, NY (US)

Correspondence Address: BERENATO, WHITE & STAVISH, LLC, 6550 ROCK SPRING DRIVE, SUITE 240, BETHESDA, MD, 20817, US

(21) Appl. No.: 11/783,256

(22) Filed: Apr. 6, 2007

Related U.S. Application Data
(60) Provisional application No. 60/789,592, filed on Apr. 6, 2006.

(51) Int. Cl. B41J 29/38; B41J 2/01; B41J 3/00

(52) U.S. Cl. 347/101; 347/102; 347/2; 347/16

(57) ABSTRACT

An automated method of printing discernable images or letters on the sides of publications or other bound soft cover printed media. The process affords the ability to print subsequent images on pre-printed publications that can provide selective advertising or other information in a visible way. In a preferred embodiment the fanned face of magazine is exposed to increase the printed surface area. The present method of printing on the sides of publications provides additional information and imagery without compromising the pre-printed pages.

This application claims the befit of Provisional application 60/789,592 filed on Apr. 6, 2006 and is hereby incorporated herein by reference.

### BACKGROUND OF THE INVENTION

1. Field of the Invention

The present invention is directed to a method of printing on the sides of an assembly of pages, and more particularly to an automated method of printing on the sides of publications.

2. Description of the Related Art

Printed publications are well known in the art. Magazines, books, brochures, and other bound and unbound assemblies of printed pages have been in existence for centuries. It is also known to gild with gold, silver, or pigment foil the sides (head, face, and foot) of hardcover bound books for ornamental purposes. It is further known to hand paint the head, face, and foot of bound publications. Combinations of gilding and painting were also used. In rare medieval bibles, text pages were fanned open, hand painted with landscapes, then returned to the closed position and then gilded on the edges to hide the painting when the book was closed. It is also known to rubber stamp the face of library books to designate library ownership. There is one other technique that I am aware of for getting an image on the face and sides of a bound book. When an image is printed on the front and back of a page and the image bleeds off (goes past the trim), the edge of the page becomes discolored or darkened by the ink, which is on both of its surfaces. This technique systematically divides an image into thin strips, which are printed off the edge of the page. When the pages are trimmed and stacked, the bleed images combine to produce a larger image. These prior art means are unsatisfactory for large-scale production of printing on the side of publications. Heretofore, the prior art is void of an acceptable method of economically printing discernable images on the side (head, face, and foot) of an assembly of stacked sheets of published material.

### SUMMARY OF THE INVENTION

The present invention seeks to alleviate the drawbacks of the prior art by providing an automated way in which to print discernable images or letters on the sides of publications. The process affords the ability to print subsequent images on pre-printed publications that can provide selective advertising or other information in a visible way. The head of a magazine is one potential area for printing (A). The face of a closed publication is a second area (B). The foot is a third area (C). When a magazine is fanned open, with the cover facing up, there is a fourth area that becomes visible (D). When a magazine is fanned backward and the cover faces down, there is a fifth area for potential exploitation (E). One or any combination of these areas can be printed with this new invention. It also provides the means to provide additional information and imagery without compromising pre-printed pages. These and other benefits will be recognized by those skilled in the art by a description of the preferred methods of printing on the sides of publications along with the attached drawings.

### BRIEF DESCRIPTION OF THE DRAWINGS

Fig A depicts a conventional publication.

Fig B depicts a magazine holder employed according to the method of the present invention.

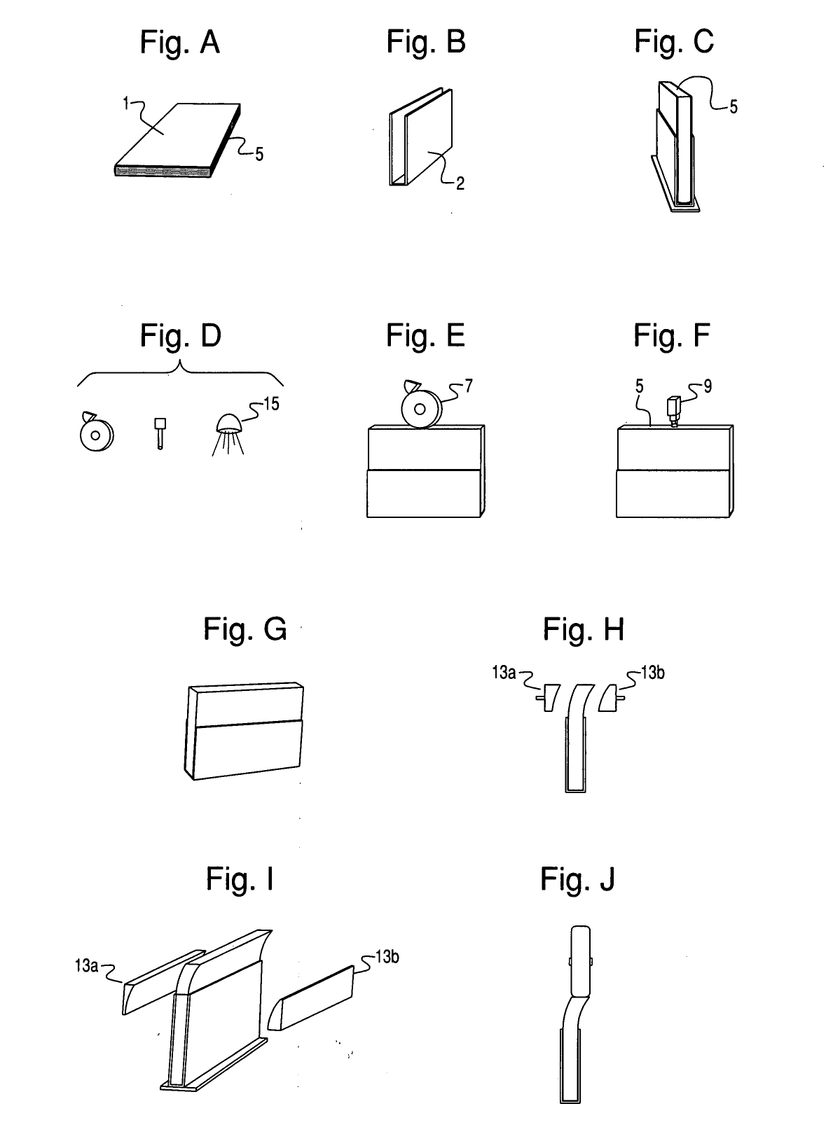

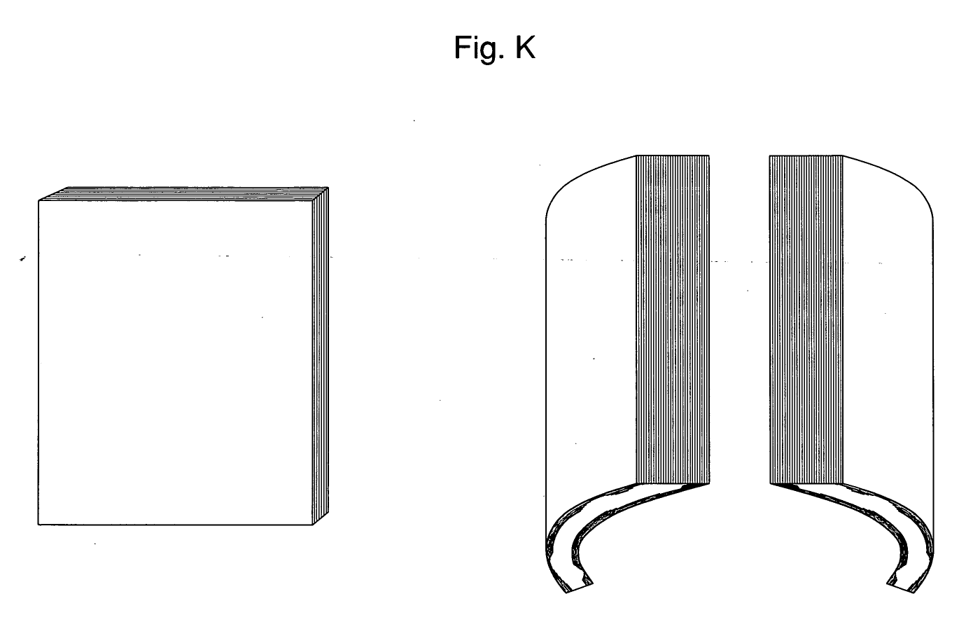

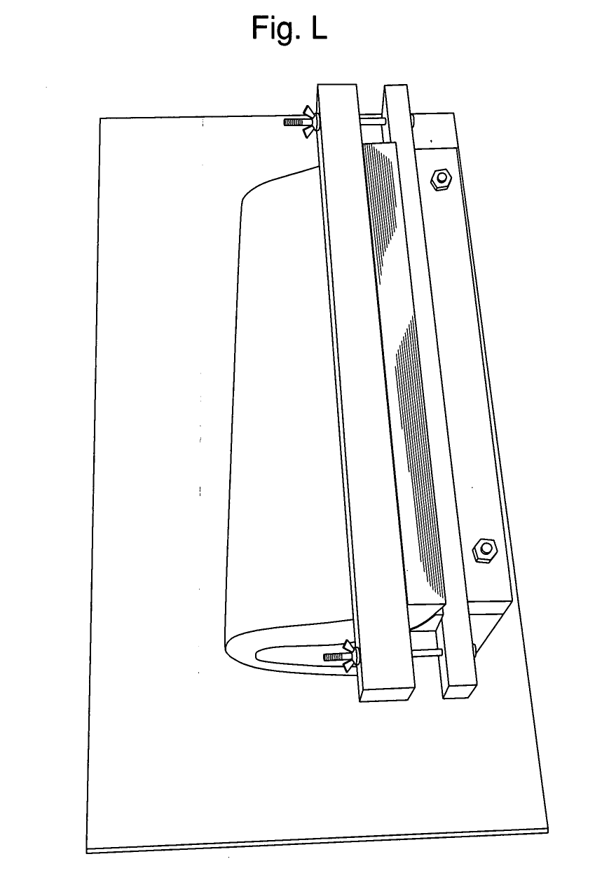

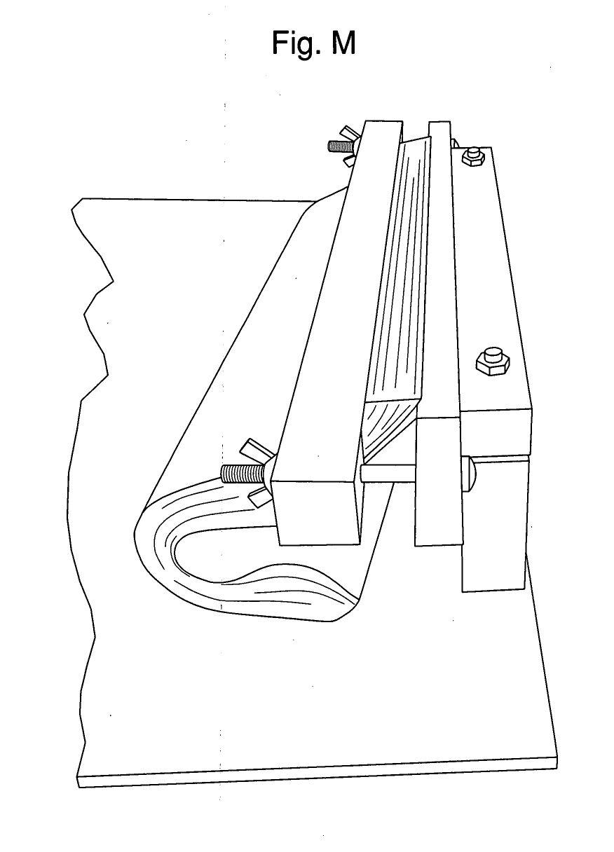

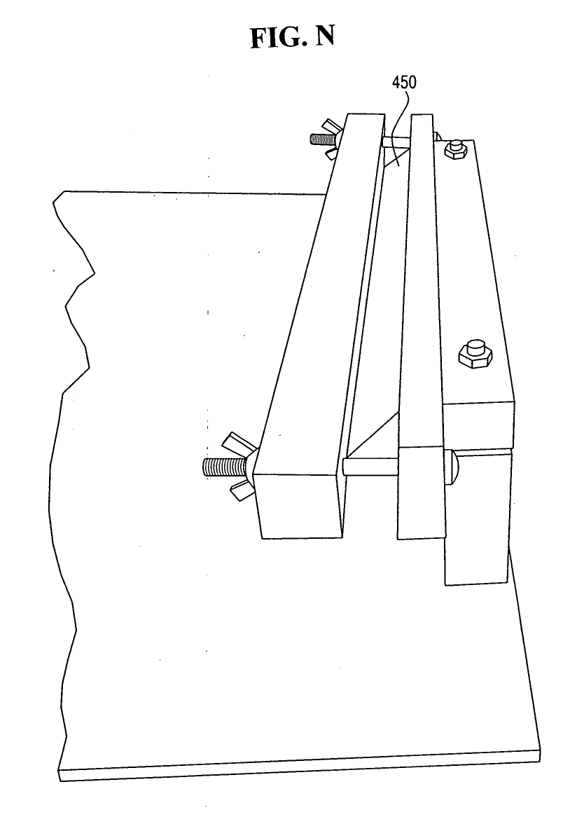

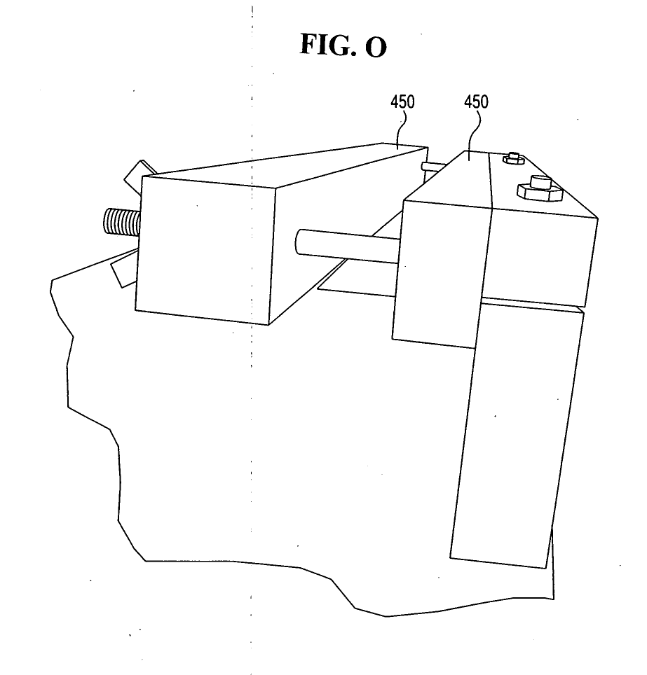

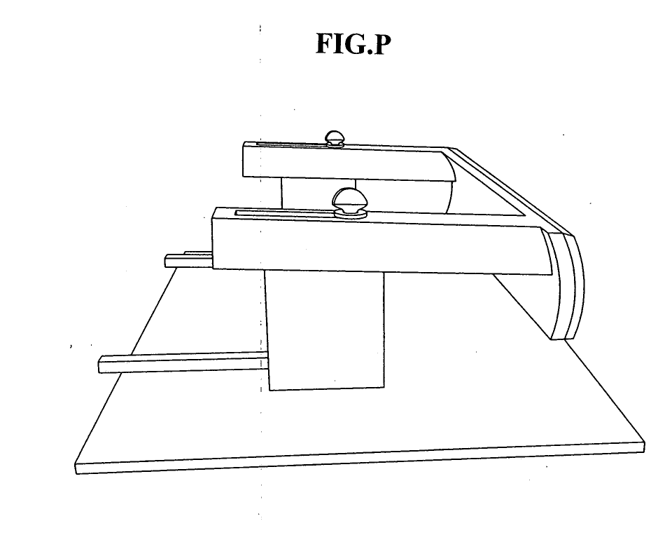

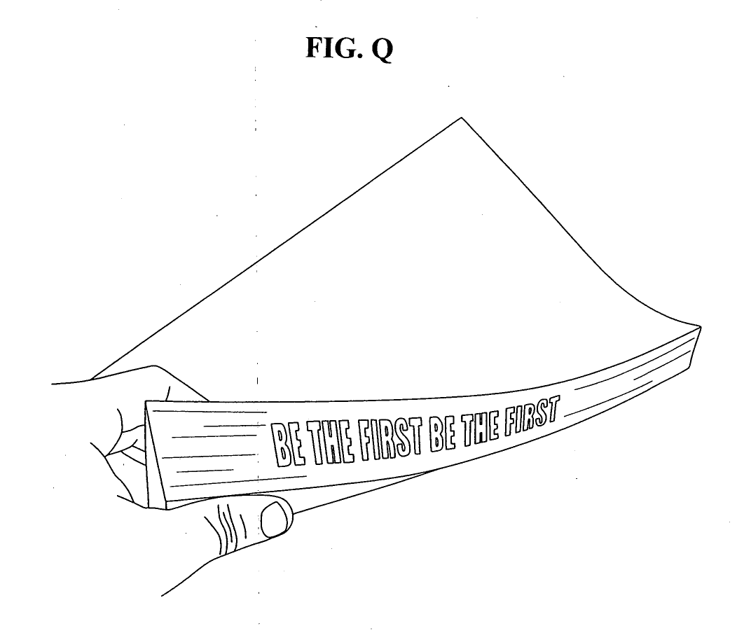

Fig. C & G depict a magazine disposed in the holder of FIG. 2.

Figs. D-F depicts a plurality if imaging depositing and drying implements employed in the method of the present invention.

Figs. H-I depict ad exploded view of clamps employed to fan the magazine according to the method of the present invention.

Fig. J depicts an ink roller depositing ink on the face side of a magazine according to the method of the present invention.

Fig. K depicts a flat magazine and a magazine fanned in different directions.

Figs. L-M depicts a fanned magazine disposed in the clamp according to the method of the present invention.

Figs. N-O depicts different side views of the clamp used to fan the magazine prior to printing according to the present invention.

Fig. P depicts a variant clamp to fan the magazine according to the method of the present invention.

Fig. Q depicts a magazine with an image printed on the face side according to the method of the present invention.

### DESCRIPTION OF THE INVENTION/PREFERRED EMBODIMENTS

Reference numeral 1 depicts a conventional magazine, Vogue™ for example. The method according to the present invention provides for an automatic means to print an image, text, or other information on the sides, preferably the face of the magazine. Reference numeral 2 depicts a holder for the magazine. The holder is adjustable to accommodate publications of various thicknesses and firmly positions the publication to expose the face (side) surface for printing. The magazine could also lay down on its front or back and travel along a conveyor belt and be imaged. Reference numeral 5 depicts the face (side) of the publication for printing. Several mechanisms for depositing the image or other printing on the surface will now be explained.

In a first embodiment, a roller (numeral 7) is employed to print on the face of the publication. An inkwell is positioned adjacent to the roller, and the holder (numeral 2) together with the publication (numeral 1) is caused to translate relative to the roller. As the publication translates relative to the axis of the roller, the roller deposits, paints, or inks or otherwise prints on the face. The roller employs either flexographic, lithographic, or rotograveur technology (a printing process where the plate—rather than blanket or roller—comes into direct contact with the paper and deposits ink). A plate could also be made of a soft sponge. One, or a combination of these techniques, can deposit either a solid coverage of ink or an image. As the roller spins, it absorbs ink from the ink well and subsequently deposits it on the face of the publication. Various colors and types of ink or paint may be employed. In the first embodiment, the publication comes in contact with the spinning stationary roller as the magazine moves past. (The magazine could remain stationary and the roller could instead move.) By this means, the image is transferred onto the face of the magazine. After the face has been printed, the next piece in the assembly line follows. In this way, printing a generic image or text on the face of a large number of publications can be accomplished. Magazines could be fed into rollers by mechanical means or by hand. It is to be understood that rolling printing per se, such as on a flat unitary surface, is known to the one of ordinary skill in the art and further elaboration regarding the details of rolling printing is not necessary.

In a similar alternate embodiment, an ink jet printer head may be employed. Ink Jet printer heads are commonplace in printing names and addresses on publications or personalizing information on letters in the mailing industry. Ink jet technology is commonplace on high end computer printers, which are available to most homes. Both of these uses for ink jet printers employ a unitary flat surface. Conventional computer algorithms exist for translating the print head along a print line coupled with advancement of the surface of the material to be printed to generate an overall image. According to the present invention, images to be printed on the face of the publication are sized and apportioned to fit within the area of a single translational printing of a conventional ink jet print head. The print head, or multiple printheads, can either move relative to the magazine or remain stationary as the magazine goes past it. In this way, conventional software may be employed to control the deposit of ink from the ink jet print head. The print station simply needs to be reconfigured to accommodate the reorientation of the publication on its side, within the holder (numeral 2). The publication face is positioned within the boundaries of the print head (numeral 9) and translational movement and an associated computer simply programmed to deposit the image. The print head or magazine thus moves along the face of the publication while depositing ink onto the face surface. This process can either be partially automated where an operator simply loads and reloads subsequent publications in holder (numeral 2) and initiates the print sequence over and over again. Or the holder (numeral 2) may be automated to translate along an assembly and return line where an operator or machine simply loads successive holders with a publication for face printing. In this fully automated process, a simple convey and return assembly may be employed to successively convey a plurality of holders through the printing station proximate the print head. Sensors or other trigger mechanisms would simply initiate the print sequence once the holder (numeral 2) and publication are properly positioned. This technology could be used to print the same information over and over again, or it could used to print personalize, variable data on the magazine (or publication/book?).

In another alternate embodiment of the present invention, two other surfaces (Areas D and E as pictured above) are manipulated and exposed as potential landscapes for printing. In this embodiment the holder (numeral 2) employs a pair of opposite curved plows (numerals 13 a, 13b) to deflect the face surface to expose a larger surface. This allows for print medium (paint, ink, etc.) to be deposited on angle, creating an image that is only exposed when the publication is fanned open. To increase adhesion of the print medium, the exposed fanned area can be roughened or sanded to increase adhesion of the print medium. A bundle of publications were taped together and the exposed fanned surface area sanded so that the fanned edge was smooth which improved adhesion dramatically.

In yet another embodiment, an Ultra Violet ink may be employed. In this embodiment any and all of the aforementioned described printing techniques may be employed. After printing, the wet ink is exposed to a U.V. light that cures the ink immediately. This process results in a hard, dry ink that does not smear or bleed and allows other inks to print on top of it.

Preferably the print medium should remain somewhat flexible after curing is preferred due to the flexibility of the side surfaces of the magazines.

In order to avoid ink binding past the edge surface onto the page, one should compensate the images using under color removal. Under color removal in four color printing, the red/blue/yellow inks are pulled out of the shadow areas and are replaced with black ink. The advantage of under color removal is that is not essential to have to use multiple layers of ink to achieve the density needed for shadows as well as reducing the overall quantity of ink applied

The drawing figures L through P depict two racks made of acrylic that held the magazines in an upright fanned position. The racks have a clear base so that I one can properly position them onto the bed to ensure that the magazines would be printed on in the correct location. In an attempt to avoid damaging the UV lamps any metal or reflective surfaces are covered. The racks holds the magazine perpendicular to the inkjet head and allowed for positioning magazines exactly beneath the inkjet head facilitated by the clear acrylic platform to which the rack was attached. Several identification marks can be placed on the printer bed indicated where the inkjet heads should be positioned for proper orientation during printing. Care should be taken so as to not over fan the face side. As can be seen in M through S a base member supports an upright member which in turn supports to clamp members. One clamp member is removable by simply removing wind the wing nuts from the bolts which extend from the opposing clamp member. The clamp members are chamfered or angled approximately 45 degrees such as best depicted in figures M-O. The clamps can be widened to accommodate publications of various thicknesses. Figures L-O depict a magazine disposed in the holder with the face sides in a fanned state exposing the surface area which has been printed. Figure Q depicts a publication which has been printed on the face side.

Another objective of the present invention is to print the face of a magazine with high-quality variable data images at great speed. This creates the need to integrate two divergent technologies 1. high-quality ink jet out-door signage material; 2. high-speed mechanized bindery equipment. A flatbed printer and could be retrofit it to inkjet a magazine that stands on its side. One such possible printer which may be modified is the Aellora Digital Surefire 65 print engine using a hybrid UV-curable jetting ink. The surefire 65 print engine integrates multiple piece drop-on-demand inkjet assemblies with a robust heated ink delivery system for reliable jetting hybrid UV-curable white and colored inks. Print modules with rack-mount enclosure and related items, control box, and cables connecting print module to control box, Microsoft net interface software with print engine control kit can be employed to control the print head to produce the desired image.

In order to facilitate high speed printing on a large number of printed publications/magazines, a bindery system needs to be employed. Utilizing such a system requires a delivery mechanism or bindery to convey the magazines to an inkjet head printing stations. The rack/holder would be integrated into an bindery system for conveyance to the print head and curing stations. One such system that could be employed is off-line book feeder from SIM model PL501 Auto-loader that can feed books to a SF505 Book Feeder. An auto-loader is necessary to achieve high speeds. The Book Feeder could feed magazines towards a modified 675 turn-over belt. The turn-over belt could then be modified to flip the publications 90 degrees to travel on their spines. The publications may then be processed via pusher chain or a belt system, such that they are held firmly. Once held, the face of each publication may be fanned to left or right to allow for printing. The machine will be able to adjust how much the books are fanned, which is important in producing the right type of print. After the print area, the books will be laid over onto a 5 foot flat-belt conveyor to wards the print head controllers. Such a system can integrate 2 opaque white inkjet stations and four color process with the entire delivery system in a 10-foot length. The final part of the magazine printing device was the integration between the delivery system and inkjet heads. Under this arrangement the 480 volts/3 phase would likely be needed to power the assembly. The speed of the equipment would be 300 cycles/minute and it would run on house air and house vacuum which will likely require a 480 volt three phase power source.

While the foregoing invention has been shown and described with reference to preferred embodiments, including the attached drawing sheets depicting figures A through Q and associated notations in said drawings, it will be understood by those possessing skill in the art that various changes and modifications may be made without departing from the spirit and scope of the invention.

What is claimed is:

1. A method of printing on a face side of a soft cover printed publication; said method including the steps of:
fanning said face side of said soft cover printed publication to a fanned state to expose an increased surface area wherein said magazine cover;
placing said soft cover printed publication in a magazine holder so as to maintain said face side in said fanned state with said exposed increased surface area;
depositing an ink printing onto said exposed increased area of said face side of said soft cover printed publication.

2. The method according to claim 1, wherein said step of depositing said ink printing on said exposed increased area includes;
positioning said holder adjacent an inkjet printer such that said face side is adjacent a print head of said inkjet printer;
translating said face side relative to said print head while said print head deposits ink there onto thereby depositing an image onto said exposed increased surface area.

3. The method according to claim 2 wherein said step of depositing said ink printing onto said exposed increased area includes depositing an ultra violet curable ink; said method including the follow steps;
after said step of depositing said ink printing onto said exposed increased area, exposing said ink printing to ultra violet radiation and curing said ink and thereafter removing said soft cover publication from said holder and relaxing said face side to an unfanned state.

4. An automated method of printing an image on side faces of a plurality of bound printed publications;
placing a first one of said bound printed publication adjacent a printing mechanism and printing a first image on a first face side of said first one of said bound printed publications;
placing a second one of said plurality of bound printed publications adjacent said printed mechanisms and reprinting said first image on a second face side of said second one of said plurality of bound printed publications.

5. The method according to claim 4, wherein said printing mechanism is an inkjet printer and said steps of placing said first and second ones of said plurality of bound printed publications adjacent said printing mechanism includes placing said first and second face sides adjacent said print head and causing relative translational movement between said face sides and said print head while said print head deposits a print medium onto said first and second face sides thereby creating said first image onto each of said first and second face sides.

6. The method according to claim 4, wherein said printing mechanism includes a roller and inkwell positioned adjacent said roller, and said steps of placing said first and second ones of said plurality of bound printed publications adjacent said printing mechanism includes placing said first and second face sides adjacent to and engaging said roller and causing relative translational movement between said face sides and said roller such that said roller rotates absorbing a print medium from said inkwell and subsequently depositing said print media on said first and second face sides and thereby creating said first image thereon.

7. The method according to claim 5 wherein print medium comprises an ultra violet curable medium; said method including the follow steps;
after said step of depositing said print medium onto said first and second face sides, exposing said print medium to ultra violet radiation and thereby curing said print medium.

8. The method according to claim 6, wherein print medium comprises an ultra violet curable medium; said method including the follow steps;
after said step of depositing said print medium onto said first and second face sides, exposing said print medium to ultra violet radiation and thereby curing said print medium.
